(19) United States
(12) Patent Application Publication
(10) Pub. No.: US 2020/0359836 A1
(43) Pub. Date: Nov. 19, 2020

(54) COOKING APPLIANCE WITH A REMOTE CONTROL AND METHOD FOR CONTROLLING SUCH A COOKING APPLIANCE

(71) Applicant: ELECTROLUX APPLIANCES AKTIEBOLAG, Stockholm (SE)

(72) Inventors: Thomas SCHULZ, Rothenburg ob der Tauber (DE); Kurt REUL, Rothenburg ob der Tauber (DE)

(21) Appl. No.: 16/962,677

(22) PCT Filed: Jan. 14, 2019
(86) PCT No.: PCT/EP2019/050805

§ 371 Date: Jul. 16, 2020

(30) Foreign Application Priority Data
Jan. 23, 2018 (EP) 18153082.5

(51) Int. Cl. A47J 36/32; F24C 7/08

(52) U.S. Cl. CPC A47J 36/321; F23N 2223/38; F24C 7/085

(57) ABSTRACT

A cooking appliance for heating food comprises a remote control for controlling the cooking appliance remotely. According to the present invention a distance control is provided for detecting the distance between the remote control 10 or a user and the cooking appliance.

The present invention refers a cooking appliance according to the preamble of claim 1 and a method for controlling such a cooking appliance according to claim 6.

Known cooking appliances can comprise a remote control for controlling the cooking appliance remotely.

However, using a remote control and performing remote operation of a cooking appliance comprises a risk since unattended use of a cooking appliance could e.g. lead to an overheating situation and therefore to a fire. Unattended use of a cooking appliance therefore is forbidden in some countries.

It is therefore an object of the present invention to improve the existing solutions and to provide a cooking appliance with a remote control and a respective method for controlling a cooking appliance wherein this risk is reduced.

The above object is solved by the present invention wherein a distance control is provided for detecting the distance between the remote control or a user and the cooking appliance. The cooking appliance can be a hob, a baking oven or another appliance for heating food.

Providing for a distance control for detecting the distance of the remote control and the cooking appliance leads to the benefit that it can be controlled whether a critical distance is exceeded. As a result a critical situation can be detected wherein the remote control is used for controlling the cooking appliance without a user being close enough to the cooking appliance so as to be able to attend and watch the cooking. In such a situation it might be overseen that the heated food or pan or pot is already too hot or will be further heated so that the danger of a fire might occur.

The same benefit can be achieved by detecting the distance not between the remote control and the cooking appliance but directly between a user and the cooking appliance. In this case it is directly controllable whether the user is close enough to the cooking appliance so as to attend the cooking.

According to the inventive method of claim 6 a distance control is provided for detecting the distance between the remote control or a user and the cooking appliance and the detected distance between the remote control or the user and the cooking appliance is used to control the interaction between the remote control or to control the cooking appliance itself.

This leads to the benefit that e.g. the function of the remote control or the controlling of the cooking appliance by means of the remote control can be limited or turned off. Hence, an increasing of the heating power of the cooking appliance can be prevented in case a user and/or the respective remote control is too far away from the cooking appliance so as to guarantee an attended cooking. In case the cooking appliance itself is detecting such a situation, the heating power can be reduced or switched off in order to reduce the risk of a fire.

Preferred embodiments are defined in the dependent claims.

The distance control preferably is a wireless distance control.

In a preferred embodiment the distance control includes a capacitive sensor which further preferably is comprised in the cooking appliance. Such a capacitive sensor can be used to detect the presence of a user and in addition the distance between the user and the cooking appliance so that it can be controlled whether the user is close enough to the cooking appliance so as to control and attend the cooking. In case the capacitive sensor is comprised in the cooking appliance itself no further sensor or detector needs to be included in the remote control or worn by the user. In case the distance between the user and the cooking appliance is reduced or increased the respective capacitive sensor changes its capacity which can be used to derive the distance.

As an alternative the distance control can use radio frequency (RF) techniques such as Bluetooth, Wi-Fi, WLAN, ZigBee, Z-Wave, or RFID techniques.

RFID uses electromagnetic fields to automatically identify and track tags attended to objects. The tag contains electronically stored information. Passive tags collect energy from the nearby RFID reader's interrogating radio waves. Such a reader can be comprised in the cooking appliance. This leads to the benefit that only a passive tag needs to be included in the remote control in contrast to an active tag which itself would require a connection to a source of electrical power.

In case the distance control is based on Bluetooth, Wi-Fi, WLAN, ZigBee or Z-Wave techniques, the respective connection between the remote control and the cooking appliance which is used to control the heating appliance by means of the remote control is also used for measuring and controlling the distance between the remote control and the cooking appliance. Therefore no additional reader or transmitter is required for performing the distance control.

The attenuation of a RF signal is a function of the distance from the source. This can be used to calculate or determine the distance between the remote control and the cooking appliance. This results in the benefit that the connection between the remote control and the interface of the cooking appliance, that is used for the control of the cooking appliance by means of the remote control, in addition is used to determine the distance between the remote control and the cooking appliance. The RF signal that is used to transmit commands and instructions from the remote control to the cooking appliance is used to determine this distance by evaluating the attenuation of the RF signal. Assuming e.g. a point-source radiation of such a RF signal emitted from the cooking appliance or the remote control, the intensity of the RF signal received by the remote control or the cooking appliance is inversely proportional to the square of the distance from the source.

The dependency of the signal intensity and/ or of the connection between the remote control and the cooking appliance on the distance can thus be used to determine the distance between the cooking appliance and the remote control.

In a further preferred embodiment a smart device such as a smartphone or a tablet computer is used as remote control. It is known to use software applications (“Apps”) running on a smartphone or tablet computer for controlling house hold appliances. According to the present invention such a smart device not only is used to control a cooking appliance so that no additional remote control is necessary. Since a distance control can be provided for detecting the distance between the smart device and the cooking appliance the discussed benefits regarding the security of the remote control is achieved too. Smart devices typically use Bluetooth, Wi-Fi or WLAN techniques for connecting to a household appliance. By monitoring the attenuation of the respective RF signal and/or the quality or single strength of the connection between the smart device and the cooking appliance, the distance between the smart device and the cooking appliance can be evaluated and respective measures can be taken in case this distance becomes too large.

According to a preferred embodiment of the inventive method remotely controlling the cooking appliance by means of the remote control is limited or inhibited in case the detected distance is beyond a limit. Unattended control of the cooking appliance can thus be avoided.

In addition or as an alternative the cooking appliance can be switched into a safe operation mode in case the detected distance is beyond the limit. This results in the benefit that as soon as a user or a remote control leaves the secure distance for attended cooking, respective measures can be taken so as to reduce the risk of a fire.

Such a safe operation mode may include a complete switch-off of all heating zones of the cooking appliance or of a mains power switch of the cooking appliance.

The respective limit for the distance between the cooking appliance and the remote control can be adjustable so that the respective function can be adapted to specific situations (such as specific installation situations).

Preferred distance limits are between 30 cm and 300 cm, more preferably between 50 and 100 cm, which assures that a user together with his remote control is in eye contact with the cooking appliance so as to assure attended cooking.

1. A cooking appliance for heating food, the cooking appliance comprising a remote control for controlling the cooking appliance remotely;
wherein a distance control is provided for detecting a distance between the remote control or a user and the cooking appliance.

2. The cooking appliance according to claim 1, wherein the distance control is a wireless distance control.

3. The cooking appliance according to claim 2, wherein the distance control includes a capacitive sensor, in the cooking appliance.

3. The cooking appliance according to claim 2, wherein the distance control uses radio frequency (RF) techniques selected from among Bluetooth, Wi-Fi, WLAN, ZigBee, Z-Wave, and RFID techniques.

4. The cooking appliance according to claim 3, wherein the detection of the distance is based on the attenuation of an RF signal as a function of the distance between the remote control and the cooking appliance.

5. The cooking appliance according to claim 1, wherein a smart device is used as the remote control.

6. Method for controlling a cooking appliance for heating food, the cooking appliance comprising a remote control for controlling the cooking appliance remotely;
wherein a distance control is provided for detecting a distance between the remote control or a user and the cooking appliance, and wherein the detected distance between the remote control or the user and the cooking appliance is used to control an interaction with the remote control or to control the cooking appliance itself.

7. Method according to claim 6, wherein remotely controlling the cooking appliance by means of the remote control is limited or inhibited in case the detected distance is beyond a predetermined limit.

8. Method according to claim 6, wherein the cooking appliance is switched into a safe operation mode in case the detected distance is beyond a predetermined limit.

9. Method according to claim 8, wherein the switching into a safe operation mode includes switching off all heating zones of the cooking appliance and/or of a mains power switch of the cooking appliance.

10. Method according to claim 7, wherein the predetermined limit is adjustable.

11. Method according to claim 7, wherein the predetermined limit is between 30 cm and 300 cm.

12. Method according to claim 6, wherein a smart device is used as the remote control.

13. A cooking appliance system comprising:
a cooking appliance comprising a plurality of heating zones adapted to heat food for cooking and a distance control; and
a remote control comprising a smart device executing an app adapted to control the cooking appliance, said remote control being in operative wireless communication with said cooking appliance via a wireless signal and being configured to transmit control commands, via said wireless signal, to the cooking appliance to operate said plurality of heating zones to perform one or more cooking processes;
the distance control comprising a capacitive sensor adapted to detect and measure an attenuation of said wireless signal, the attenuation being correlated to a distance between said remote control and said cooking appliance;
the cooking appliance being adapted to cease accepting at least one of said control commands transmitted by said remote control if the distance therebetween as determined by said distance control exceeds a predetermined distance.

14. The cooking appliance system according to claim 13, said appliance being further adapted to switch off all the heating zones of the cooking appliance if the distance between said remote control and said cooking appliance exceeds said predetermined distance.

15. The cooking appliance system according to claim 13, said smart device communicating with the cooking appliance via said wireless signal over BlueTooth or over a WiFi network, the predetermined distance being between 30 cm and 300 cm.

16. Method according to claim 11, the predetermined limit being between 50 cm and 100 cm.
